(19) United States
(12) Patent Application Publication
(10) Pub. No.: US 2025/0252367 A1
(43) Pub. Date: Aug. 7, 2025

(54) ARTIFICIAL INTELLIGENCE-BASED SYSTEM AND METHOD FOR AUTOMATING JOB MATCHING

(71) Applicant: myQuickHR Sdn Bhd, Kuala Lumpur (MY)

(72) Inventors: Ravindran Rabindran, Kuala Lumpur (MY); Roziha Ab Kadir @ Mohd Khadir, Kuala Lumpur (MY); Tracy Swee Lin Kok, Kuala Lumpur (MY)

(21) Appl. No.: 18/604,056

(22) Filed: Mar. 13, 2024

(30) Foreign Application Priority Data
Feb. 2, 2024 (MY) PI2024000758

(51) Int. Cl. G06Q 10/0631; G06F 40/40; G06Q 10/1053

(52) U.S. Cl. CPC G06Q 10/063112; G06F 40/40; G06Q 10/1053

(57) ABSTRACT

The present artificial intelligence-based system (100) automates job matching by evaluating each candidate's resume against job requirements. It includes a user interface (102) for administrators to upload job descriptions and candidate resumes, a database directory module (104) for data storage, a document extension module (106) for file verification, and a processing module (108) with a Large Language Model (110), at least one vector database (118), and a Scoring module (112). The processing module interprets resume contents through machine-readable instructions, performs similarity searches, and scores candidates in real-time based on their suitability for each job requirement. The method (200) of the present invention involves receiving and managing job descriptions and resumes, verifying document formats, processing resumes and job descriptions, and displaying ranked results. Within the processing step (208), the method further encompasses processing and interpreting resume contents, scoring candidates for real-time suitability, and comparing qualifications and skills against job descriptions.

### FIELD OF INVENTION

The present invention relates to an artificial intelligence-based system and method for automating job matching. In particular, the present invention provides an artificial intelligence-based system for automating job matching by assessing each candidate resume to each job requirement system which optimizes the job matching process.

### BACKGROUND ART

Talent acquisition is a critical function within organizations, encompassing the processes involved in identifying, attracting, assessing, and ultimately hiring qualified individuals to fulfil organizational needs. As the cornerstone of human resources management, talent acquisition plays a pivotal role in securing the right talent to drive business success. Effective talent acquisition is imperative for organizations striving to stay competitive in dynamic markets. The quality of the workforce directly impacts an organization's innovation, productivity, and overall performance. Strategic talent acquisition contributes to building a skilled, diverse, and engaged workforce, fostering a positive work environment and driving organizational growth.

Conventionally, evaluating candidates in the talent acquisition process involves a multi-step process where job openings are posted, resumes are collected, candidates are interviewed, and final selections are made. The current landscape of talent acquisition faces significant challenges and drawbacks. One of the major drawbacks in using conventional candidate evaluation systems include the labor-intensive nature of reviewing candidates resumes manually. This process consumes considerable organizational resources, resulting in delays in filling critical roles. Furthermore, the subjective nature of manual reviews introduces the potential for biases, impacting the fairness and diversity of the recruitment process. Therefore, traditional methods do not efficiently consider the diverse skills and experiences of candidates, often leading to mismatches and protracted hiring cycles.

Numerous candidate evaluation method have been developed in the application of recruitment process.

One example of a candidate evaluation method is disclosed in U.S. Pat. No. 10,832,219 B2 (hereinafter referred to as U.S. 219 B2 Patent) entitled “Using feedback to create and modify candidate streams” having a filing date of Mar. 30, 2018, Applicant: Microsoft Technology Licensing LLC. The U.S. 219 B2 Patent discloses a method for creating a stream of candidates based on attributes such as locations and titles, which are suggested to a user, and refining the stream based on user feedback. The U.S. 219 B2 Patent also discloses generating communications such as messages and alerts related to the stream.

Another example of a fabrication method of evaluating candidates is disclosed in U.S. Pat. No. 11,238,410 B1 (hereinafter referred to as U.S. 410 B1 Patent) entitled “Methods and systems for merging outputs of candidate and job-matching artificial intelligence engines executing machine learning-based models” having a filing date of Dec. 17, 2019, Applicant: ICIMS Inc. The U.S. 410 B1 Patent discloses a method for merging outputs of matching artificial intelligence, AI engines that are configured to match jobs to candidates, candidates to candidates and jobs to jobs. Furthermore, the methods disclosed by U.S. 410 B1 also illustrates how multiple artificial intelligence engines or algorithms executing machine learning-based models can be used to identify candidates or jobs that match other candidates or jobs.

A further example of a method for evaluating candidates is disclosed in US Patent Publication No. US20200394592 A1 (hereinafter referred to as U.S. 592 A1 Publication) entitled “Generating a machine-learned model for scoring skills based on feedback from job posters”, having a filing date of Jun. 17, 2019, Applicant: Microsoft Technology Licensing LLC. The U.S. 592 A1 Publication discloses a method for scoring data items using a machine-learned model by identifying multiple skills and attributes from a job posting, and identifying multiple probabilities, where each probability corresponding to a different attribute value of the identified attribute values. The U.S. 592 A1 Publication further discloses that the probabilities are input into a machine-learned model to generate multiple scores.

As outlined above, various candidate evaluation methods have been developed for the recruitment process. However, none of the prior arts disclose a system/method that efficiently consider the diverse skills and experiences of candidates, and thereby providing an automated job matching process.

In light of the foregoing discussion, there exists a need to provide an improved system and method for evaluating candidates for recruitment process that overcome at least the aforementioned drawbacks.

### SUMMARY OF INVENTION

The present invention relates to an artificial intelligence-based system and method for automating job matching. In particular, the present invention provides an artificial intelligence-based system and method for automating job matching by assessing each candidate resume to each job requirement system.

One aspect of the present invention provides an artificial intelligence-based system (100) for automating job matching by assessing each candidate resume to each job requirement. The system (100) comprising at least one user interface (102) for at least one administrator to upload at least one job description (114) and a plurality of candidate resumes (116) or at least one candidate resume (116) and a plurality of job description (114) into the system and for displaying returned results of candidates ranked according to suitability of each job requirement. The system further comprises at least one database directory module (104) for storing and managing structured and unstructured data including job descriptions and candidate resumes uploaded onto the system; at least one document extension module (106) coupled to the at least one database directory module (104) for verifying file type or format of document by examining file extension of documents stored in the at least one database directory module (104); and at least one processing module (108) coupled to the at least one document extension module (106) for processing candidate resumes and job descriptions uploaded into the system. The at least one processing module (108) comprises at least one Large Language Model module (110) for processing and interpreting contents of candidates resume through machine-readable instructions; at least one vector database (118) coupled to the at least one Large Language Model module (110) and at least one Scoring module (112). The at least one vector database (118) is employed for performing similarity searches with an embedding vector and the at least one Scoring module (112) is employed for scoring candidates based on candidates suitability for each job requirement through for a real-time scoring based on content of candidates resume.

Another aspect of the present invention provides that the at least one Scoring module (112) is a rubric-based scoring module having scoring templates.

A further aspect of the present invention provides that the at least one Scoring module (112) comprises at least one work experience module (112a), at least one project scoring module (112b), at least one qualification module (112c), and at least one skill scoring module (112d). The at least one work experience module (112a) is employed for computing scores based on relevant experience of each of the candidate resume matching with the job description. The at least one project scoring module (112b) is employed for computing scores based on at least one relevant project provided in each of the candidate resume matching with the job description. The at least one qualification module (112c) for computing scores based on at least one relevant qualification data of each of the candidate resume matching with the job description, and the at least one skill scoring module (112d) for computing score based on at least one relevant skill provided in each of the candidate resume matching with the job description.

Yet another aspect of the invention provides that the at least one Scoring module (112) further comprises Job Matching algorithm for comparing and pairing qualifications and skills of candidates on candidates resumes against the job descriptions by utilizing information extracted and computed by the at least one Scoring module (112).

Still another aspect of the invention provides that the machine-readable instructions is Natural Language Processing which is a branch of artificial intelligence.

Another aspect of the present invention provides a method (200) for automating job matching by assessing each candidate resume to each job requirement through artificial intelligence. The method (200) comprises steps of receiving at least one job description and a plurality of candidate resumes or at least one candidate resume and a plurality of job description uploaded by an administrator (202). In receiving at least one job description and a plurality of candidate resumes, job matching is performed by matching the plurality of candidate resumes received to one job description. Alternatively, in receiving one candidate resume and a plurality of job description allows for the one candidate resume to be matched to multiple job descriptions to determine the suitability of jobs available for the candidate. At step (204), the method comprises storing and managing structured and unstructured data including job descriptions and candidate resumes received. Further, the method at step (206) comprises verifying file type or format of received document by examining file extension of documents stored in step 204. Furthermore, the method at step (208) comprises processing candidate resumes and job descriptions and at step (210), the method comprises displaying returned results of candidates ranked according to suitability of each job requirement. The method of processing candidate resumes and job descriptions comprises steps of (300) which includes processing and interpreting contents of candidates resume through machine-readable instructions at step (302); scoring candidates based on candidates suitability for each job requirement for a real-time scoring based on content of candidates resume at step (304); and thereafter comparing and pairing contents of candidates resumes against contents of each job description by utilizing information extracted and computed by the at least one Scoring module, at step (306).

Yet another aspect of the invention provides that the step of processing and interpreting contents of candidates resume through machine-readable instructions (302) further comprises steps of (400) generating embeddings for each document of candidates resume and job description (402), creating retrievers for each of candidates resume and job description from the embeddings generated in step 402 (404); merging retriever created for candidate resume and retriever created for job description as a single document (406); creating filters for embedding and compressing the merged single document (408); creating a master retriever for consistency and accuracy (410); and creating a prompt template that utilizes information from the master retriever to iteratively create an ideal question from information obtained from original two documents one from candidates resume and the other from job description from step 404 to ensure evaluation question is optimized (412).

Still another aspect of the invention provides that generating embeddings for each document of candidates resume and job description (402) further comprises steps of (500) tokenizing each of the plurality of candidate resume and the job description (502); semantically analysing each of the tokenized candidate resumes and the job description (504); assessing context of textual data pertaining to each of the candidate resumes and the job description (506); and generating the embeddings associated with each documents of candidate resume and the job description from the contextually assessed textual data (508).

A further aspect of the invention provides that the step of scoring candidates based on candidates suitability for each job requirement through scoring templates for a real-time scoring based on content of candidates resume (304) further comprises steps of (600) creating rubric-based scoring system having at least one scoring template for analyzing and matching content of candidates resume based on a predefined criteria from job description on the at least one scoring template from each individual module of the Scoring module for real time scoring of candidates resume (602); retrieving final scores from each individual module of the Scoring module; and ranking candidates based on scores computed (604).

Yet another aspect of the present invention provides that analyzing and matching content of candidates resume based on a predefined criteria from job description on the at least one scoring template for real time scoring of candidates resume (602) further comprises steps of (700) scoring candidates work experience based on relevant experience of each of the candidate resume matching with the job description (702); scoring candidates project completion based on at least one relevant project provided in each of the candidate resume matching with the job description (704); scoring candidates basic qualification based on at least one relevant qualification data of each of the candidate resume matching with the job description (706); and scoring candidates skill based on at least one relevant skill provided in each of the candidate resume matching with the job description (708).

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a schematic illustration of an artificial intelligence based system for automated job matching, in accordance with an embodiment of the present invention;

FIG. 1a illustrates schematic illustration of scoring modules, in accordance with an embodiment of the present invention;

FIG. 2 is a flowchart illustrating a method for automated job matching, in accordance with an embodiment of the present invention;

FIG. 3 is a flowchart illustrating a method for processing candidate resumes and job descriptions, in accordance with an embodiment of the present invention;

FIG. 4 is a flowchart illustrating a method for processing and interpreting contents of candidates resume through machine-readable instructions, in accordance with an embodiment of the present invention;

FIG. 5 is a flowchart illustrating a method for generating embeddings for each document of candidates resume and job description, in accordance with an embodiment of the present invention;

FIG. 6 is a flowchart illustrating a method for scoring candidates based on candidates suitability for each job requirement through scoring templates for a real-time scoring based on content of candidates resume, in accordance with an embodiment of the present invention; and

FIG. 7 is a flowchart illustrating a method for analyzing and matching content of candidates resume based on a predefined criteria from job description on the at least one scoring template for real time scoring of candidates resume.

### DETAILED DESCRIPTION OF THE DRAWINGS

The present invention relates to an artificial intelligence-based system and method for automating job matching. In particular, the present invention provides an artificial intelligence-based system and method for automating job matching by assessing each candidate resume to each job requirement system.

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

The present invention provides a job matching system driven by artificial intelligence, aiming to automate and enhance the effectiveness of candidate evaluations, thereby ensuring a more efficient and impartial recruitment procedure.

With the present invention, the labour-intensive manual tasks associated with recruitments are significantly diminished, and biases in the hiring process are mitigated. Additionally, the present invention offers an automated job matching solution that takes into account candidates varied skills and experiences via an AI-based algorithm, resulting in a precise and impartial hiring process.

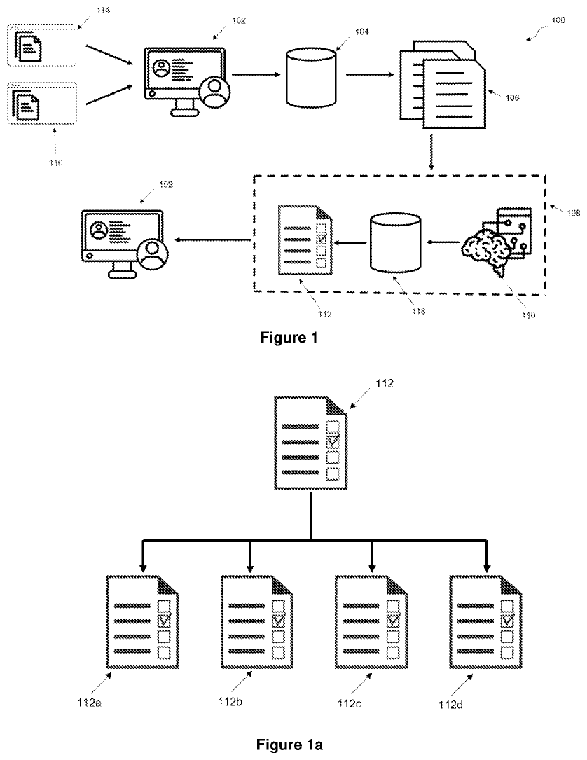

Reference is first made to FIG. 1. FIG. 1 depicts a schematic representation of an artificial intelligence-based system configured for automated job matching, wherein each candidate resume is systematically assessed against individual job requirements, as per an embodiment of the present invention. The system (100) is configured with at least one user interface (102) to facilitate administrators in the uploading process, enabling the introduction of either a job description (114) and a plurality of candidate resumes (116), or vice versa. Said user interface (102) additionally serves the function of presenting the outcomes of candidates, methodically ranked based on their suitability for each job requirement. Furthermore, the system incorporates at least one database directory module (104), specifically dedicated to the storage and management of both structured and unstructured data, encompassing the uploaded job descriptions and candidate resumes.

Additionally, the system (100) includes at least one document extension module (106), intricately linked to the database directory module (104), configured for validating the file type or format by scrutinizing the file extension of documents residing within the database directory module. Moreover, within the system (100), a processing module (108) is integrated, coupled with the document extension module (106), to undertake the processing of candidate resumes and job descriptions introduced into the system. Notably, the processing module (108) is characterized by the presence of at least one large language model module (110), at least one vector database (118) coupled to the at least one large language model module (110), and at least one scoring module (112) coupled to the aforementioned large language model module (110). The at least one large language model module (110) is configured to process and interpret the contents of candidates resumes via machine-readable instructions. Furthermore, the at least one vector database (118) coupled to the at least one Large Language Model module (110) is configured for performing similarity searches with an embedding vector. Moreover, the at least one scoring module (112), coupled to the large language model module (110), is configured to evaluate candidates based on their suitability for each job requirement, utilizing real-time scoring derived from the content of candidates resumes.

In describing further on FIG. 1, reference is made to FIG. 1a, wherein there is illustrated a schematic illustration of scoring modules (112), in accordance with an embodiment of the present invention. In one embodiment, the at least one scoring module (112) is configured as a rubric-based scoring module featuring scoring templates. In another embodiment, the at least one scoring module (112) comprises distinct modules, including at least one work experience module (112a) operable to compute scores based on the relevant experience outlined in each candidate's resume in alignment with the job description. Additionally, the at least one scoring module (112) includes at least one project scoring module (112b) operably configured for computing scores based on relevant project details in each candidate's resume matching the job description. Furthermore, there is at least one qualification module (112c) operably configured to compute scores based on relevant qualification data in each candidate's resume matched with the job description, and at least one skill scoring module (112d) operably configured to compute scores based on relevant skills provided in each candidate's resume matching with the job description.

Optionally, each scoring module incorporate scoring templates for evaluating a score pertaining to candidate's resume, based on analysing and matching the content of the candidate's resume with the content of the job description. Specifically, such templates gauge the relevance of scores assigned to individual candidate resumes. For example, a score of ‘0’ in the scoring template of skill scoring module, indicates that the candidate lacks the specified skills outlined in the job description. Alternatively, a score of ‘1’ signifies that the candidate possesses some of the required skills mentioned in the job description. Similarly, a score of ‘2’ suggests that the candidate predominantly possesses the necessary skills outlined in the job description. Moreover, a score of ‘3’ denotes that the candidate not only possesses all the required skills mentioned in the job description but also possesses additional relevant skills.

Upon evaluating the scores of a candidate resume associated with each of the scoring modules (112), the processing module (108) aggregates the computed scores from each of scoring modules (201-208) pertaining to each of the candidate profiles and display the plurality of candidate profiles in a ranked order on the user interface, according to the aggregated computed score. In an embodiment, the processing module (108) outputs the score of the plurality of candidate resumes in JSON format.

In yet another embodiment, the at least one scoring module (112) further comprises a job matching algorithm that compares and pairs qualifications and skills of candidates on candidates resumes against the job descriptions by utilizing information extracted and computed by the at least one scoring module (112). Optionally, the job matching algorithm is an Artificial Intelligence based algorithm. Specifically, the job matching algorithm is designed to methodically compare and align the qualifications and skills delineated in candidates resumes with the stipulated requirements outlined in the job descriptions. To accomplish this, the algorithm leverages the information extracted and computed by the at least one scoring module (112). In essence, this algorithm utilizes the processed data from the scoring module to facilitate a thorough assessment, establishing meaningful connections between the qualifications, projects, skills, and experience associated with the candidate resumes and the specified criteria within the job descriptions.

In a particular embodiment, the machine-readable instructions is natural language processing which is a branch of artificial intelligence.

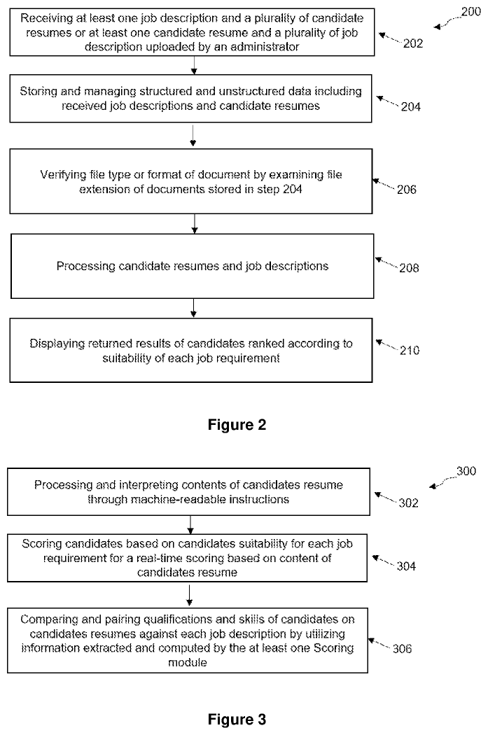

Referring to FIG. 2, there is illustrated a flow chart of a method (200) for automated job matching by assessing each candidate resume to each job requirement via artificial intelligence, comprising a series of steps. The method (200) commences with step (202), wherein at least one job description and a plurality of candidate resumes, or at least one candidate resume and a plurality of job descriptions, are received, and the uploading of the at least job description and the plurality of candidate resumes, is facilitated by an administrator. Subsequently, in step (204), the method comprises storing and managing, structured and unstructured data, including the received job descriptions and candidate resumes. Continuing to step (206), the method comprises verifying the file type or format of documents by examining the file extension of the stored documents in step (204). Following this, the method (200) includes step (208) which includes the processing of candidate resumes and job descriptions. Finally, the method (200) comprises at step (210) displaying returned results of candidates, systematically ranked according to the suitability of each job requirement.

In describing further on FIG. 2, reference is made to FIG. 3, wherein there is illustrated a flowchart of a method for processing candidate resumes and job descriptions comprising the steps of (300). The method initiates at step (302), which includes processing and interpreting contents of candidates resume through machine-readable instructions. Furthermore, the method at step (304) includes scoring candidates based on candidates suitability for each job requirement for a real-time scoring based on content of candidates resume. Moreover, the method also comprises at step (306) which includes comparing and pairing contents of candidates resumes against contents of each job description by utilizing information extracted and computed by the at least one Scoring module.

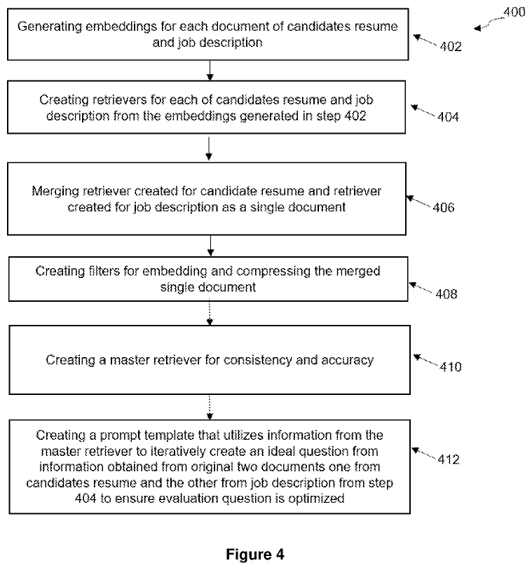

Referring to FIG. 4, there is illustrated a flow chart of a method (200) for processing and interpreting contents of candidates resume via machine-readable instructions (302). Said method comprises the steps of (400). The method, at step (402), comprises generating embeddings for each document of candidates resumes and job descriptions. At step (404), the method involves creating retrievers for each candidate resume and job description from the embeddings generated in step 402. Moving to step (406), the method comprises merging the retrievers created for the candidate resume with the retriever created for the job description into a single document. Subsequently, at step (408), the method includes creating filters for embedding and compressing the merged single document. Progressing to step (410), the method comprises creating a master retriever to ensure consistency and accuracy in the information. Finally, at step (412), the method involves creating a prompt template that utilizes information from the master retriever to iteratively form an optimal evaluation question. This question is generated from information obtained from the original two documents—one from the candidate's resume and the other from the job description in step 404—ensuring the evaluation question is optimized.

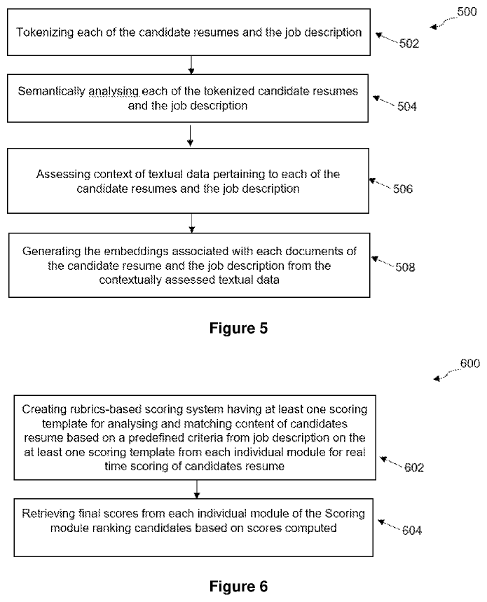

Referring to FIG. 5, there is depicted a flow chart illustrating a method (200) for generating embeddings for each document of candidates resumes and job descriptions, involving the steps (500). Generating and using embeddings transpired in a vector database involves a plurality of steps. A vector database handles vector embeddings, often used in machine learning to represent complex data like including images, or audio. These steps include creating embeddings, storing the embeddings in a vector database, and thereafter querying the database for various applications including similarity search or recommendation systems. In general in generating embedding, a model is trained or chosen for embedding generation by selecting a pre-trained model suitable for data type. An example of a pre-trained model is Open A1. Thereafter, the data is pre-process. In pre-processing the data, the data in text format is formatted to be with the pre-trained model and the text is being tokenized. Thereafter, embeddings are generated by transmitting the data through the trained model and each piece of data which includes a text document is transformed into a vector of numbers. Subsequently, a vector database is set up by selecting the type of vector database. The vector database is configured according to the specific requirements, such as setting up indexing methods for efficient similarity searches. The embeddings are stored in the vector database by inserting the generated embeddings into the vector database. The vector database is thereafter queried by performing similarity searches by querying with an embedding vector. The database returns the most similar vectors from the stored embeddings. The vector database can be integrated into larger systems or applications.

As for the present invention, the method (200) for generating embeddings for each document of candidates resumes and job descriptions, commences at step (502), wherein tokenization is applied to each of the plurality of candidate resumes and the job description. Embedding is the vector representation of the tokens whereby in the present invention embedding refers to “words” within the candidate profiles and job description. Subsequently, at step (504), the method further involves semantically analyzing each of the tokenized candidate resumes and the job description. Continuing to step (506), the method assesses the context of textual data related to each of the candidate resumes and the job description. Finally, at step (508), the method generates embeddings associated with each document of the candidate resume and the job description from the contextually assessed textual data.

Referring to FIG. 6, a flow chart is presented outlining a method (200) for scoring candidates based on their suitability for each job requirement through scoring templates, enabling real-time scoring based on the content of candidates' resumes, with steps (600). The method (200) commences at step (602), entailing the creation of a rubric-based scoring system featuring at least one scoring template. This template is employed for analyzing and matching the content of candidates resumes based on predefined criteria from the job description. In an alternative embodiment, the template is employed for analysing and matching the content of job descriptions based on predefined criteria from the content of candidate's resumes. Subsequently, at step (604), the method retrieves final scores from each individual module of the scoring module, ranking candidates based on the computed scores.

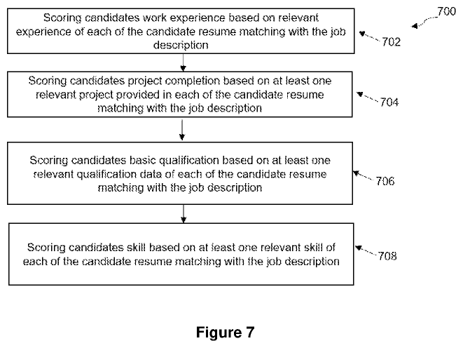

Referring to FIG. 7, a flow chart illustrates a method (200) for analyzing and matching the content of candidates' resumes based on predefined criteria from the job description, facilitating real-time scoring of candidates' resumes, encompassing series of steps (700).

The method (200) initiates at step (702) with the scoring of candidates work experience based on the relevant experience outlined in each candidate resume, aligning with the job description. Further, at step (704), the method includes scoring candidates project completion based on at least one relevant project provided in each candidate resume corresponding to the job description. Additionally, at step (706), the method involves scoring candidates basic qualifications based on at least one relevant qualification data within each candidate resume aligning with the job description. Moreover, at step (708), the method encompasses scoring candidates skills based on at least one relevant skill provided in each candidate resume matching the job description.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

1. An artificial intelligence-based system (100) for automating job matching by assessing each candidate resume to each job requirement, the system (100) comprising:
at least one user interface (102) for at least one administrator to upload at least one job description (114) and a plurality of candidate resumes (116) or at least one candidate resume (116) and a plurality of job description (114) into the system and for displaying returned results of candidates ranked according to suitability of each job requirement;
at least one database directory module (104) for storing and managing structured and unstructured data including job descriptions and candidate resumes uploaded onto the system;
at least one document extension module (106) coupled to the at least one database directory module (104) for verifying file type or format of document by examining file extension of documents stored in the at least one database directory module (104); and
at least one processing module (108) coupled to the at least one document extension module (106) for processing candidate resumes and job descriptions uploaded into the system;
characterized in that
the at least one processing module (108) comprises:
at least one Large Language Model module (110) for processing and interpreting contents of candidates resume through machine-readable instructions;
at least one vector database (118) coupled to the at least one Large Language Model module (110) for performing similarity searches with an embedding vector; and
at least one Scoring module (112) coupled to the at least one vector database (118) for scoring candidates based on candidates suitability for each job requirement through for a real-time scoring based on content of candidates resume.

2. The system (100) according to claim 1, wherein the at least one Scoring module (112) is a rubric-based scoring module having scoring templates.

3. The system (100) according to claim 1, wherein the at least one Scoring module (112) comprises:
at least one work experience module (112a) for computing scores based on relevant experience of each of the candidate resume matching with the job description;
at least one project scoring module (112b) for computing scores based on at least one relevant project provided in each of the candidate resume matching with the job description;
at least one qualification module (112c) for computing scores based on at least one relevant qualification data of each of the candidate resume matching with the job description; and
at least one skill scoring module (112d) for computing score based on at least one relevant skill provided in each of the candidate resume matching with the job description.

4. The system (100) according to claim 1, wherein the at least one Scoring module (112) further comprises Job Matching algorithm for comparing and pairing contents of candidates resumes against contents of each job description by utilizing information extracted and computed by the at least one Scoring module (112).

5. The system (100) according to claim 1, wherein the machine-readable instructions is Natural Language Processing which is a branch of artificial intelligence.

6. A method (200) for automating job matching by assessing each candidate resume to each job requirement via artificial intelligence, the method (200) comprises steps of:
receiving at least one job description and a plurality of candidate resumes or at least one candidate resume and a plurality of job description uploaded by an administrator (202);
storing and managing structured and unstructured data including received job descriptions and candidate resumes (204);
verifying file type or format of document by examining file extension of documents stored in step 204 (206);
processing candidate resumes and job descriptions (208); and
displaying returned results of candidates ranked according to suitability of each job requirement;
characterized in that
processing candidate resumes and job descriptions (208) comprises steps of (300):
processing and interpreting contents of candidates resume through machine-readable instructions (302);
scoring candidates based on candidates suitability for each job requirement for a real-time scoring based on content of candidates resume (304); and
comparing and pairing contents of candidates resumes against contents of each job description by utilizing information extracted and computed by the at least one Scoring module (306).

7. The method (200) according to claim 6, wherein processing and interpreting contents of candidates resume through machine-readable instructions (302) further comprises steps of (400):
generating embeddings for each document of candidates resume and job description (402);
creating retrievers for each of candidates resume and job description from the embeddings generated in step 402 (404);
merging retriever created for candidate resume and retriever created for job description as a single document (406);
creating filters for embedding and compressing the merged single document (408);
creating a master retriever for consistency and accuracy (410); and
creating a prompt template that utilizes information from the master retriever to iteratively create an ideal question from information obtained from original two documents one from candidates resume and the other from job description from step 404 to ensure evaluation question is optimized (412).

8. The method (200) according to claim 7, wherein generating embeddings for each document of candidates resume and job description (402) further comprises steps of (500):
tokenizing each of the plurality of candidate resume and the job description (502);
semantically analysing each of the tokenized candidate resumes and the job description (504);
assessing context of textual data pertaining to each of the candidate resumes and the job description (506); and
generating the embeddings associated with each documents of candidate resume and the job description from the contextually assessed textual data (508).

9. The method (200) according to claim 6, wherein scoring candidates based on candidates suitability for each job requirement through scoring templates for a real-time scoring based on content of candidates resume (304) further comprises steps of (600):
creating rubric-based scoring system having at least one scoring template for analyzing and matching content of candidates resume based on a predefined criteria from job description on the at least one scoring template from each individual module of the Scoring module for real time scoring of candidates resume (602);
retrieving final scores from each individual module of the Scoring module ranking candidates based on scores computed (604).

10. The method (200) according to claim 6, wherein analyzing and matching content of candidates resume based on a predefined criteria from job description on the at least one scoring template for real time scoring of candidates resume (602) further comprises steps of (700):
scoring candidates work experience based on relevant experience of each of the candidate resume matching with the job description (702);
scoring candidates project completion based on at least one relevant project provided in each of the candidate resume matching with the job description (704);
scoring candidates basic qualification based on at least one relevant qualification data of each of the candidate resume matching with the job description (706); and
scoring candidates skill based on at least one relevant skill provided in each of the candidate resume matching with the job description (708).
